(19) United States
(12) Patent Application Publication
(10) Pub. No.: US 2015/0052227 A1
(43) Pub. Date: Feb. 19, 2015

(54) APPARATUS AND METHOD FOR PROVIDING SUPPLEMENTAL CONTENT

(71) Applicant: BLOOMBERG FINANCE L.P, New York, NY (US)

(72) Inventors: Iliya Rybchin, Scarsdale, NY (US); Oke Okaro, Montclair, NJ (US); Andrew Lack, Bronxville, NY (US); Stacy Kennedy, New York, NY (US); Chris Berend, Maplewood, NJ (US); Courtney Chapman, Brooklyn, NY (US); Gregg Fenton, Northport, NY (US)

(73) Assignee: BLOOMBERG FINANCE L.P, New York, NY (US)

(21) Appl. No.: 14/459,089

(22) Filed: Aug. 13, 2014

Related U.S. Application Data
(60) Provisional application No. 61/865,289, filed on Aug. 13, 2013.

(51) Int. Cl. H04L 29/06; H04L 29/08

(52) U.S. Cl. CPC H04L 65/60; H04L 67/10
USPC 709/219

(57) ABSTRACT

The present disclosure describes a system and method for providing supplemental content. Media content is displayed on a display device. An indication is displayed on the display device to alert a user of the availability of supplemental content related to the media content if it is determined that supplemental content is available. The supplemental content is retrieved from one or more servers in response to user input, and the supplemental content is displayed on the display device by overlaying the supplemental content on top of the media content.

### BACKGROUND

As television programming has grown in popularity, the amount of information available to viewers through television programs has also grown. For example, during news programs, a “J-screen” typically displays related content on the bottom or side of the screen. If the news program is discussion a particular company, that company's stock price may be displayed in the J-screen. However, this related content is not “actionable” by the viewer. In other words, the viewer cannot interact with the content. In addition, the user cannot control whether or not the related content is displayed. The J-screen will be displayed regardless of whether the viewer is interested in the content. Furthermore, as the popularity of “smart” devices such as smart phones, tablets, and smart televisions is increasing, there is room for improvement in the way in which content is made available and presented to users on various devices.

### SUMMARY

Embodiments of the present disclosure facilitate providing and displaying supplemental content related to media content on a digital device. In accordance with an embodiment of the present disclosure, media content is displayed on a display device. It is determined if supplemental content related to the media content is available, and an indication to alert a user of the presence of the supplemental content is displayed on the display device if it is determined that supplemental content is available. User input comprising a selection of the indication may be received, and supplemental content may be retrieved from one or more servers in response to the user input. The supplemental content may then be displayed on the display device by overlaying the supplemental content on top of the media content.

In accordance with an embodiment, user input may be provided using one or more of a gesture command, voice command, touch input, and input from a remote control.

In accordance with an embodiment, availability of the supplemental content may be determined by sending a request comprising identification information of the media content to one or more servers and receiving a response from the one or more servers indicating availability of the supplemental content related to the media content.

In accordance with an embodiment, availability of the supplemental may also be determined by searching a local storage device for the supplemental content.

In accordance with an embodiment, the supplemental content comprises one or more of audio, video and graphical data.

In accordance with an embodiment, the supplemental content comprises a UI element (e.g., a button, or icon) which allows a user to initiate a video chat.

In accordance with an embodiment, the supplemental content includes one or more actionable UI elements.

The embodiments described herein may furthermore be carried out on a computing device that performs operations based on execution of code stored on a non-transitory computer readable medium.

In accordance with an embodiment of the present disclosure, a non-transitory computer readable medium having executable code stored thereon, that when executed, causes a computing device to perform at least the following steps: displaying media content on a display device; determining if supplemental content related to the media content is available; displaying, if it is determined that the supplemental content is available, an indication on the display device to alert a user of the presence of the supplemental content; receiving user input comprising a selection of the indication; retrieving the supplemental content from one or more servers in response to the user input; and displaying the supplemental content on the display device by overlaying the supplemental content on top of the media content.

The embodiments described herein may furthermore be carried out on a system comprising at least an input unit configured for receiving user input, a display unit, a storage device, and a processor. The processor may be configured for displaying media content on the display unit; determining if supplemental content related to the media content is available; displaying, if it is determined that the supplemental content is available, an indication on the display unit to alert a user of the presence of the supplemental content; receiving user input comprising a selection of the indication; retrieving the supplemental content from one or more servers in response to the user input; and displaying the supplemental content on the display unit by overlaying the supplemental content on top of the media content.

The aforementioned embodiments and other advantages of the embodiments described herein will be apparent to those of ordinary skill in the art at least by reference to this summary, the following detailed description, and the accompanying drawings.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIGS. 1A, 1B, 1C, and 1D illustrate exemplary screenshot diagrams of the embodiments of the present disclosure;

FIG. 2 illustrates an exemplary diagram of a mobile device in accordance with the embodiments of the present disclosure;

FIGS. 3A and 3B illustrate exemplary screenshot diagrams of the embodiments of the present disclosure;

FIG. 4 illustrates an exemplary diagram of a mobile device in accordance with the embodiments of the present disclosure;

FIG. 5 illustrates an exemplary block diagram showing a device in accordance with the embodiments of the present disclosure;

FIG. 6 is an exemplary block diagram of an environment in accordance with the embodiments of the present disclosure;

FIG. 7 illustrates an exemplary flow diagram showing an algorithm in accordance with the embodiments of the present disclosure; and

FIG. 8 illustrates a high-level diagram of a computing device that may be used to implement various aspects of the present disclosure.

### DETAILED DESCRIPTION

Detailed embodiments of the present disclosure are provided herein. Any and all disclosed embodiments are merely exemplary and may be embodied in various and alternative forms, and combinations thereof. As used herein, “exemplary,” and similar terms, may refer expansively to embodiments that serve as an illustration, specimen, model, or pattern. The figures may include exaggerated or minimized features, in order to adequately show details of particular components. In certain instances, well-known components, systems, materials or methods that have not been described in detail in order to avoid obscuring from the focus of the present disclosure. Therefore, specific structural and functional details disclosed herein are in no way to be interpreted as limiting, but merely as a basis for the claims and as a representative basis recognizable to one skilled in the art to employ the present disclosure.

While the detailed description may include a general context of computer-executable instructions, the present disclosure may be implemented in combination with other program modules and/or as a combination of hardware and software. Thus, terms such as “computer” or “computing device” as used herein are expansive and are meant to include routines, program modules, programs, components, data structures, algorithms, and the like. Various systems may also be used for the implementation of the embodiments described herein, including single processor or multi-processor systems, minicomputers, mainframe computers, personal computers, hand-held computing devices, microprocessor-based computers, programmable consumer electronics, in-vehicle computing devices, and any of the aforementioned combinations thereof, and the like.

Various embodiments of the present disclosure overcome one or more of the above-mentioned and other drawbacks in conventional approaches to providing supplemental content to a user. In particular, the present disclosure describes an apparatus and method for providing supplemental content to a digital device based on media content being displayed on the digital device. Digital device may mean a device capable of displaying media content such as video, audio, graphics, etc. Examples of a digital device include, but are not limited to, computers, digital televisions, smart phones, tablets, e-readers, and other audio-visual devices. In one embodiment, the supplemental content is selected based on, and is related to, the media content being displayed on the digital device.

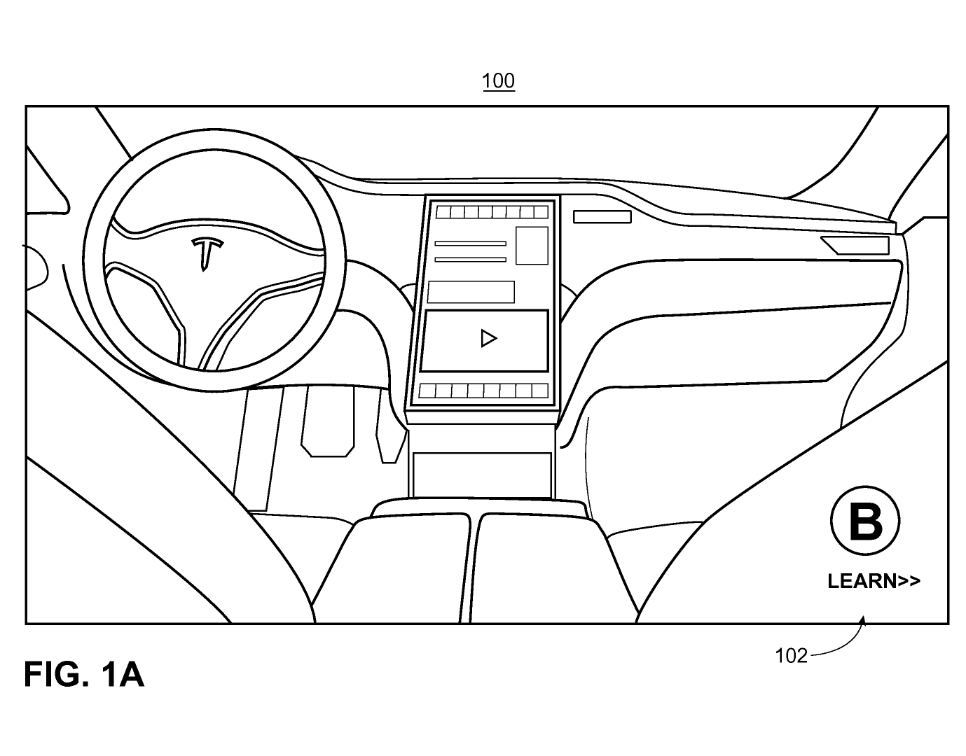

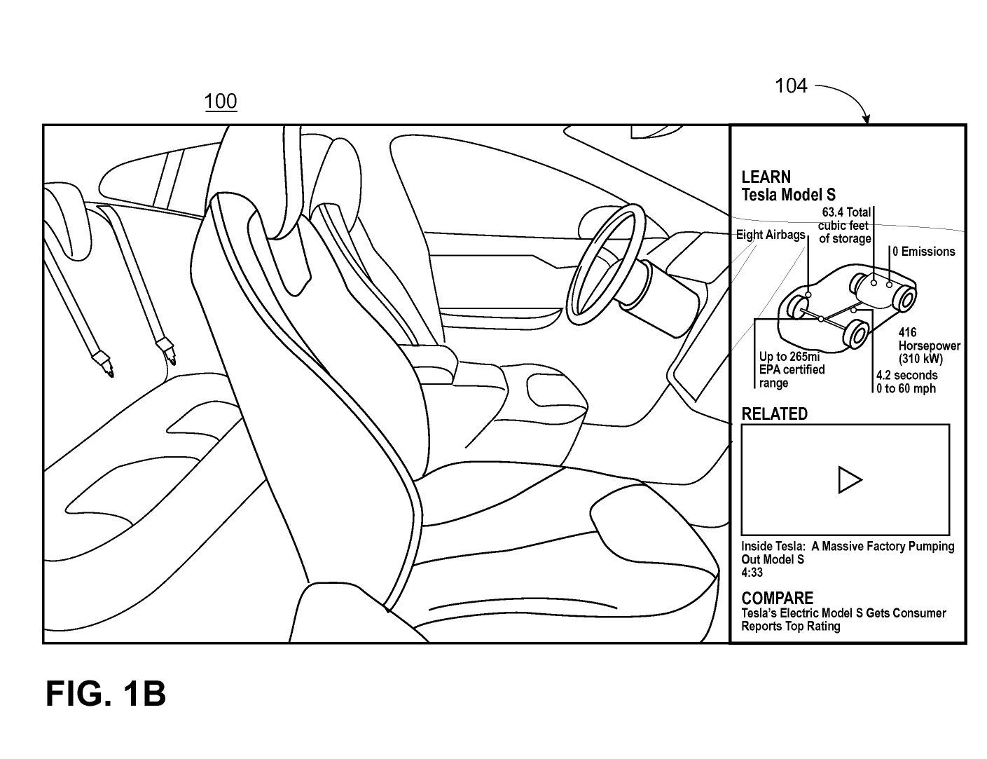

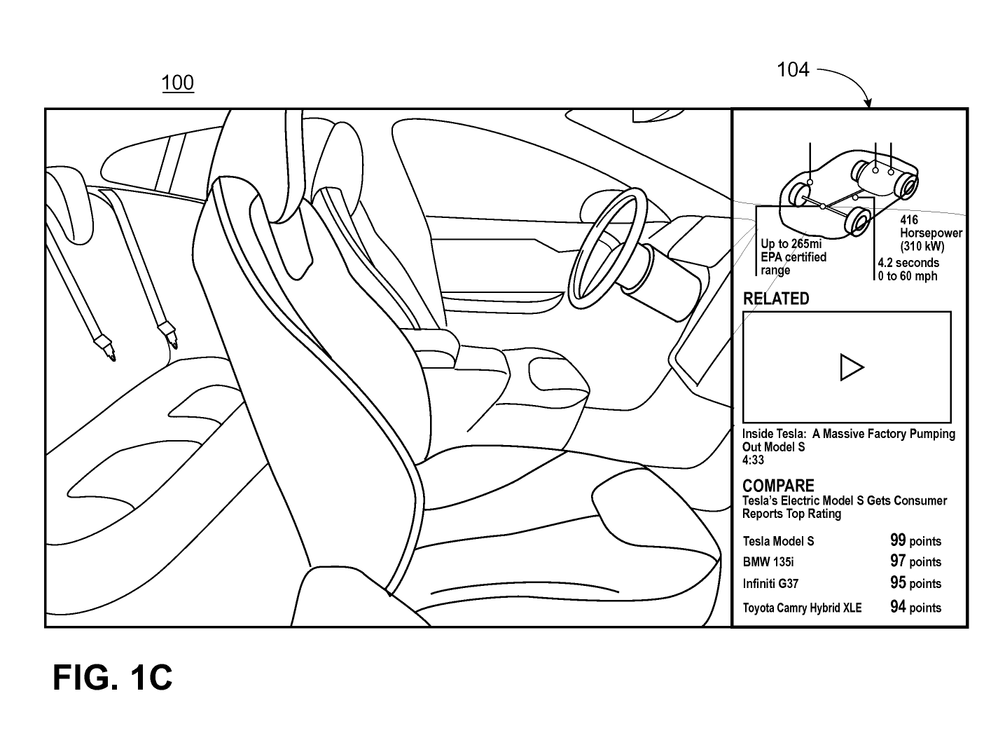

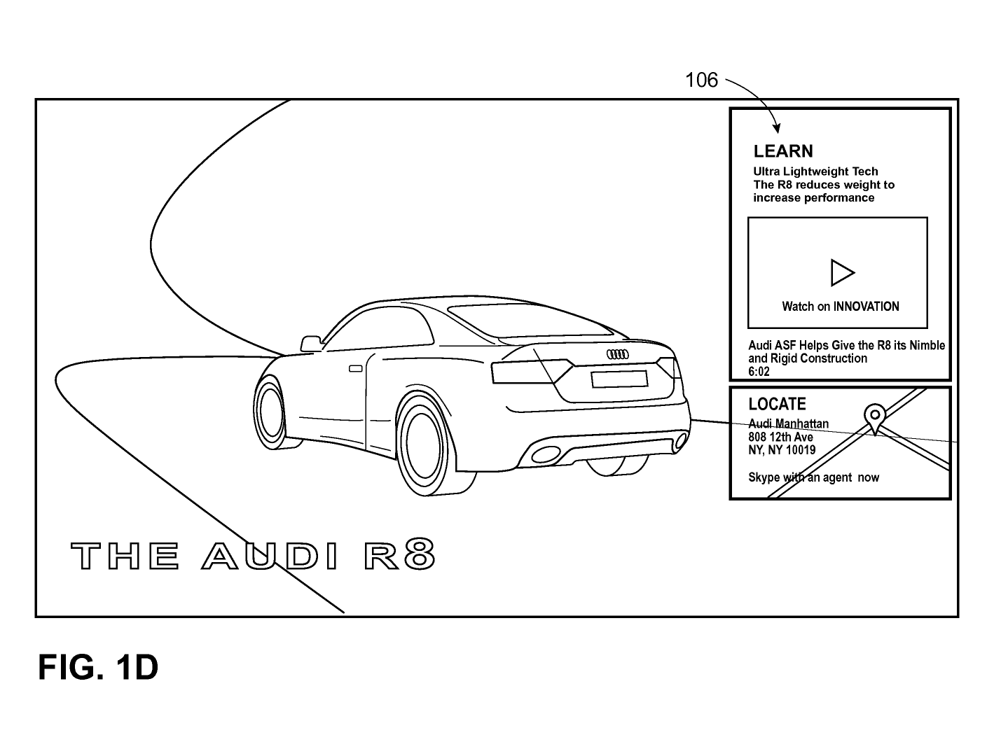

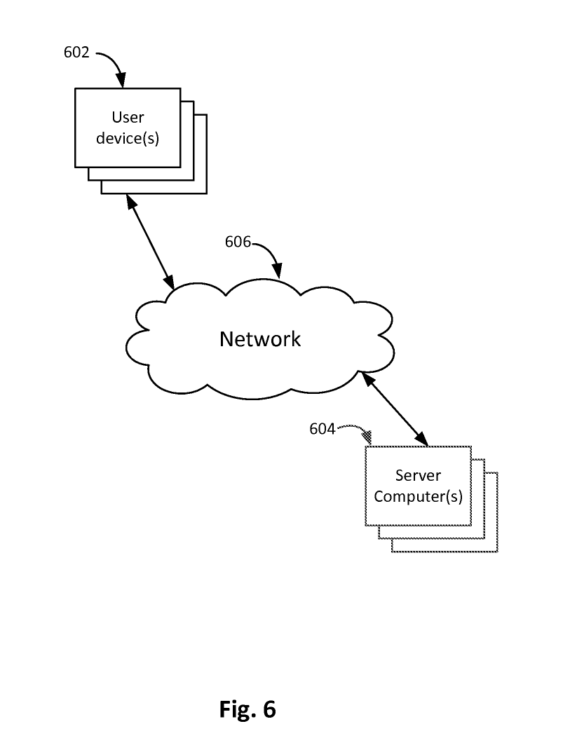

FIGS. 1A, 1B, 1C, and 1D illustrate exemplary screenshot diagrams of the embodiments of the present disclosure. FIG. 1A illustrates a display 100 of a digital device such as a television which is playing content related to a Tesla vehicle. In accordance with one embodiment, if supplemental content related to the content being displayed is available an indication may be displayed to alert the viewer of the presence of supplemental content. As shown in FIG. 1A, indication 102, which includes the “B” icon and “Learn” is displayed to alert the viewer of the presence of supplemental content. The viewer may provide input to select indication 102 using for example, a remote control, a mouse, a touch screen, a touchpad, a voice command, a gesture, etc. If indication 102 is selected, supplemental content related to the content being displayed may be retrieved and overlaid on top of the content. FIGS. 1B, and 1C illustrate supplemental content 104 related to Tesla vehicles being displayed on a portion of the display 100. Upon user selection of indication 102, the supplemental content may be retrieved from, for example, a server (e.g., server 604 from FIG. 6) which stores supplemental content. In an alternate embodiment, if supplemental content is available for the media content being displayed on the digital device, it may automatically be retrieved. Upon user selection of the indication, it may then be displayed.

As shown in FIGS. 1B and 1C, supplemental content 104 may include audio, video, textual, and/or graphical content. In the illustrated examples, supplemental content 104 includes a schematic including specifications of the Tesla vehicle is displayed. In addition, supplemental content 104 includes a video of the Tesla factory. The viewer may play the video by selecting the “play” button/icon using for example, a remote control, a voice command, a gesture, etc. Also displayed are Consumer Reports ratings of Tesla's competitors. The data comprising the supplemental content may be obtained from one or more sources (e.g., a supplemental content server) accessible via the Internet. The data may be transmitted directly to the digital device (e.g., a television) over a network such as the Internet, or may be transmitted to the device through an intermediary device such as a set top box connected to the digital device. In accordance with one embodiment, the supplemental content may be “actionable”. For example, the viewer may scroll through supplemental content 104. In addition, a viewer may interact with buttons and/or icons (e.g., a play button) as described above. The screenshot shown in FIG. 1C may be displayed after the viewer “scrolls up” from the screenshot shown in FIG. 1B.

In one embodiment, “actionable” content within the supplemental content may include for example, an option to initiate a video chat with a sales agent. FIG. 1D illustrates supplemental content 106 related to the Audi R8. The supplemental content 106 includes a video related to the R8, and also a map showing the address and location of the nearest Audi dealer. In addition, an option which allows the viewer to initiate a video chat with a sales agent is displayed. If the viewer selects the option to initiate a video chat, by selecting “Skype with an agent now”, a video chat software application such as, Skype° by Microsoft Corporation, may be launched, and a connection with the sales agent maybe established. As will be apparent to one of ordinary skill in the art, a video chat software application such as Skype° may have been previously installed on a digital device such as a smart television.

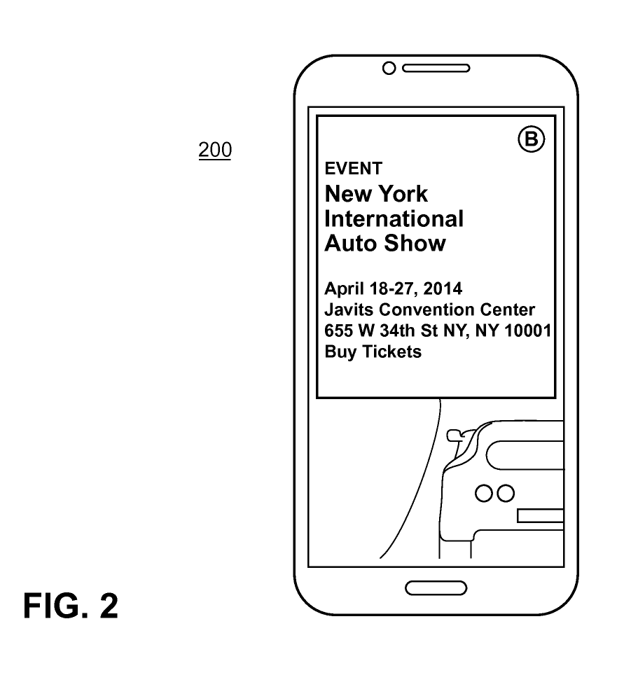

In accordance with one embodiment, supplemental content may also be provided to the viewer on one or more mobile devices. FIG. 2 illustrates a smartphone display 200 having displayed thereon supplemental content related to an auto show. As shown, the supplemental content includes a link to purchase tickets to the show. In one embodiment, if a viewer selects the link, the smartphone browser may direct the viewer to a website where tickets may be purchased. In one embodiment, the supplemental content may be transferred to the mobile device via, for example, a Wi-Fi network. In an exemplary embodiment, a television and mobile device may be connected to the same LAN, and supplemental content may be provided to a mobile device over the LAN. For example, supplemental content may be transferred to the mobile device from the television, or the set-top box. Alternatively supplemental content may be sent directly to the mobile device over the Internet.

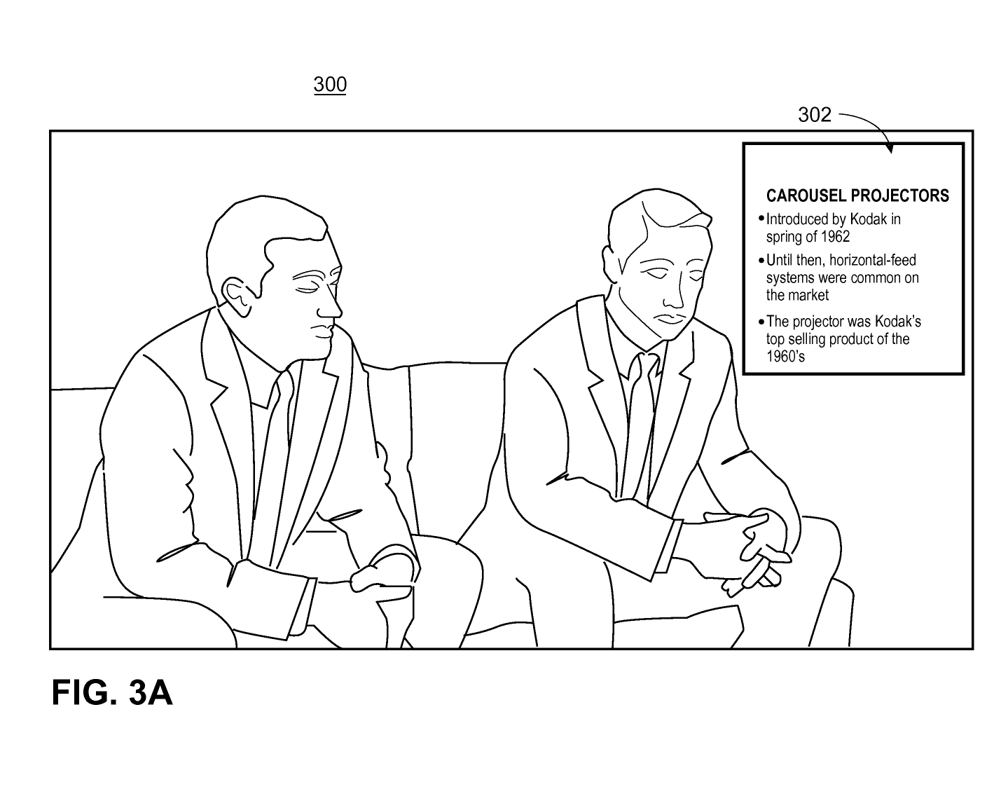

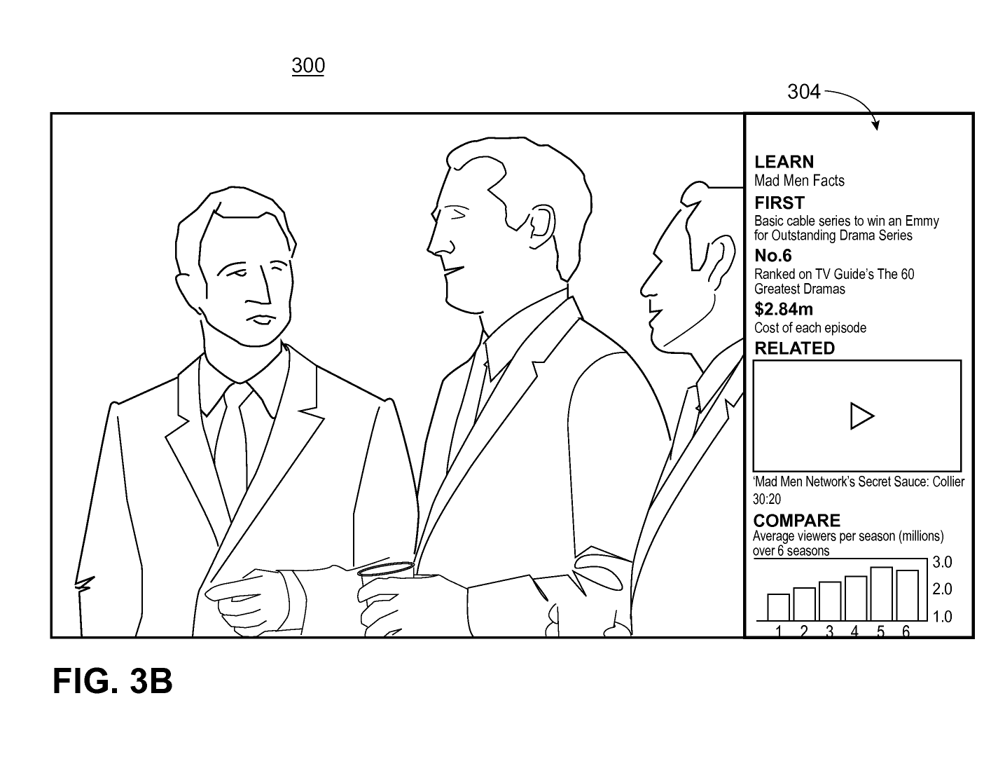

FIGS. 3A and 3B illustrate additional exemplary screenshot diagrams of a digital device display 300 showing supplemental content. In FIGS. 3A and 3B, supplemental content related to the show “Mad Men” is displayed. In the illustrated example of FIG. 3A, supplemental content 302 includes information related to carousel projectors because projectors are being discussed in the displayed scene of “Mad Men”. In one embodiment, supplemental content may include for example, information about the AMC network, information about the advertising industry portrayed in the show, financial information related to the show (e.g., gross revenue, actor salaries, etc.). In the example shown in FIG. 3B, supplemental content 304 includes facts related to the show, such as cost of each episode, average viewers per season, etc.

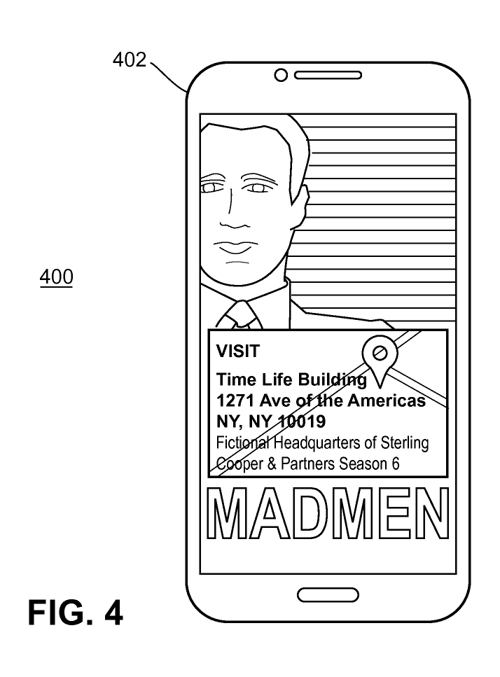

In some embodiments, supplemental content may be provided even when a user is not viewing media content on a digital device. In one embodiment, a software application installed on a user's mobile device (e.g., a smartphone) may track information such as the user's viewing habits, location information, etc. and provide supplemental content related to the content viewed by the user. FIG. 4 illustrates a smartphone display 400 having displayed thereon supplemental content 402 related to “Mad Men”. In the illustrated example, when a viewer is geographically near the fictional headquarters of the advertising firm portrayed in “Mad Men”, which is located on 1271 Avenue of the Americas in New York City, supplemental content 402 is displayed on the viewer's smartphone, as shown in FIG. 4. Supplemental content 402 includes a map with an alert indicating that the fictional headquarters of Sterling Cooper & Partners is located at that address. The viewer's location may be determined, for example, by obtaining geo location data from the smartphone or other sources.

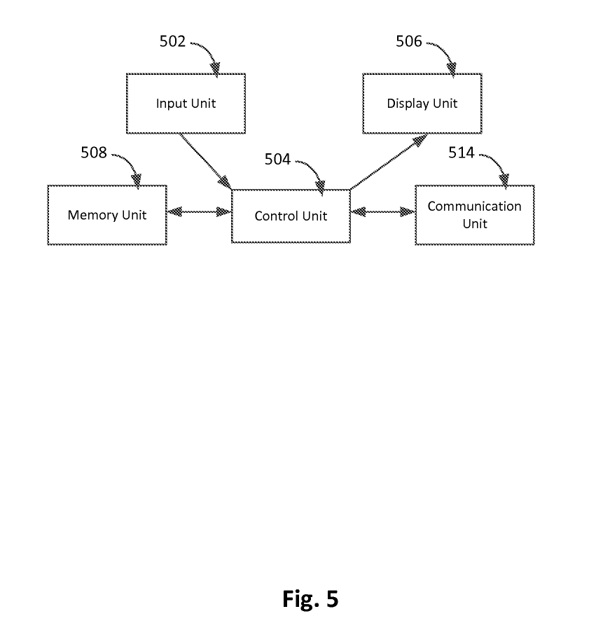

FIG. 5 illustrates an exemplary block diagram of a device 500 operating in accordance with the embodiments described herein. The digital device shown in FIG. 5 may include a control unit 504, a memory unit 508, an input unit 502, a display unit 506, and a communication unit 514.

Control unit 504 is responsible for overall control and operation of the digital device. Control unit 504 may, for example, be responsible for processing and controlling all data communications. In one embodiment, control unit 504 may be a processor. Control unit 504 is responsible for initiating display of supplemental content on the digital device via display unit 506. Display unit 506 is capable of displaying numerals and characters, moving pictures, still pictures, and status information generated during any operation of the digital device. Display unit 506 may be a color liquid crystal display (LCD) or an active-matrix organic light-emitting diode (AMOLED). The supplemental content may be displayed, for example, when the digital device receives user input indicating selection of an indicator.

Input unit 502 may comprise a keyboard, mouse, touchpad, microphone for receiving audio data and a camera for recognizing and receiving gesture data. Input unit 502 may furthermore be configured to receive tactile or touch input. Input unit 502 is responsible for receiving and processing all external input provided by an individual within the detection range to control unit 504 for processing and analysis. When control unit 504 receives the input data, control unit 504 analyzes the input data do detect the presence of for example, a voice command, gesture command, etc.

Communication unit 514 transmits/receives radio frequency (RF) signals inputted/outputted through an antenna (not shown). Communication unit 514 is also capable of receiving/transmitting data through wired communication. In an exemplary embodiment, communication unit 514 includes circuitry required for communicating via Wi-Fi, Ethernet, HDMI, USB, etc. According to an exemplary embodiment of the present disclosure, communication unit 514 transmits instructions to external sources requesting programs or information based upon the information relating to the content being displayed. The information (e.g., supplemental content) obtained by communication unit 514 may be stored in memory unit 508.

The above configurations of digital device 500 should be considered descriptively and should not be construed as limiting. Those skilled in the art will readily understand that various changes and modifications may be made to the configurations of the digital device without departing from the scope of the present disclosure. For example, although each of the input unit 502, display unit 506, memory unit 508, control unit 504, and communication unit 514 have been shown as separate units, any respective functions may be performed jointly or individually by any of the aforementioned units.

FIG. 6 is a block diagram illustrating one embodiment of an environment in which exemplary embodiments of the invention may be practiced. Not all the components may be required to practice various embodiments, and variations in the arrangement and type of the components may be made. As shown, system 600 includes network 606, one or more server computers 604, and one or more user devices 602. User device 602 may include for example, digital televisions, smartphones, tablets, desktop and laptop PCs, etc. In one embodiment, one or more user devices 602 may be digital device 500 of FIG. 5. Server(s) 604 may vary widely in configuration or capabilities, but generally may include, a CPU (not shown) coupled to memory (not shown). One or more server computers 604 may also include one or more wired or wireless network interfaces (not shown), one or more input/output interfaces (not shown), or one or more operating systems (not shown), such as Windows Server, Mac OS X, Unix, Linux, FreeBSD, or the like. Devices capable of operating as a server may include, as examples, dedicated rack-mounted servers, desktop computers, laptop computers, integrated devices combining various features, such as two or more features of the foregoing devices, or the like.

Network 606 is configured to couple network devices with other computing devices. Network 206 is enabled to employ any form of computer readable media for communicating information from one electronic device to another. Also, network 206 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 606. Furthermore, remote computers and other related electronic devices could be remotely connected to either LANs or WANs via a modem and temporary telephone link. In essence, network 606 includes any communication method by which information may travel between computing devices.

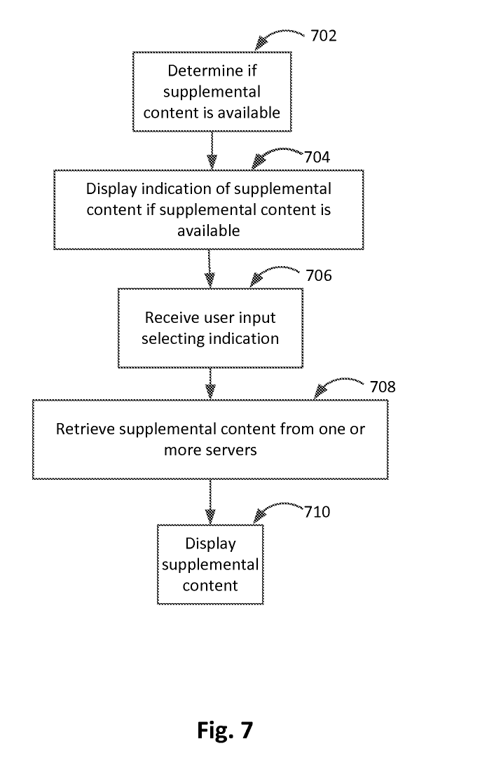

FIG. 7 illustrates an exemplary flow diagram showing an algorithm in accordance with the embodiments described herein. Method 700, as shown, illustrates an algorithm for displaying supplemental content. In an embodiment, a digital device, such as that described in reference to FIG. 5, may display supplemental content. At step 702, it is determined if supplemental content related to the media content displayed on the digital device is available. In one embodiment, this may be determined by sending a request to a server which stores supplemental content. The request may include for example the title of the program, names of one or more actors, time stamp of a particular scene, etc. If supplemental content related to the media content is available, the server may send a response indicating the availability of supplemental content. In an alternate embodiment, supplemental content may have previously been downloaded to the digital device. In such cases, determining if supplemental content is available comprises checking local storage for supplemental content related to the media content. The supplemental content may include one or more flags or meta data which may indicate the media content with which it is associated. At step 704, an indication may be displayed on the digital device. The indication may indicate the presence of supplemental content relating to the content being displayed. The indication may be for example, an icon, symbol, etc. At step 706, user input indicating selection of the indication may be received. User input may be provided using for example, a remote control, or using a voice command, gesture, etc. In response to the user input, the supplemental content may be retrieved from one or more servers in step 708. The servers may include for example, a database including supplemental content categorized by categories such as, type of program, genre, actor(s), etc. The supplemental content may be downloaded by the digital device using for example, a Wi-Fi or wired internet connection. The supplemental content may include, audio, video, textual, and/or graphical data. In step 710, at least a portion of the retrieved supplemental content may be displayed on the digital device. The supplemental content may be displayed by overlaying a portion of the display.

It shall be understood that each block of a flowchart illustration need not be limited in the ordering shown in the illustration, and might be performed in any ordering, or even performed concurrently, without departing from the spirit of the embodiments described herein. It will also be understood that each block of the flowchart illustration, and combinations of blocks in the flowchart illustration, can be implemented by execution of computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

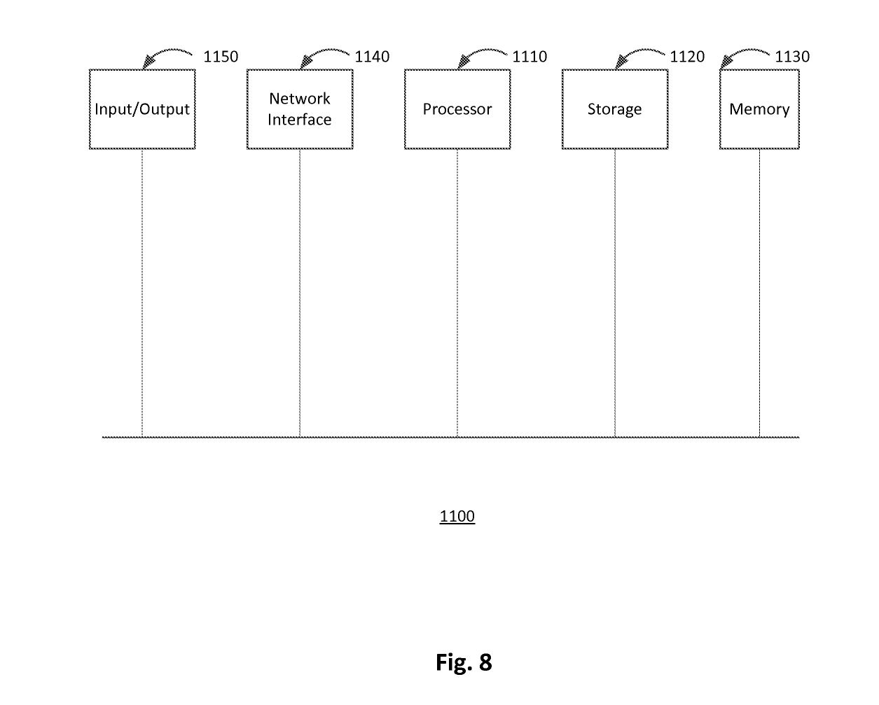

FIG. 8 illustrates a high-level diagram of a computing device that may be used to implement various aspects of the present disclosure. Computing device 1100 comprises a processor 1110 operatively coupled to a data storage device 1120 and a memory 1130. Processor 1110 controls the overall operation of computing device 1100 by executing computer program instructions that define such operations. The computer program instructions may be stored in data storage device 1120, or other computer readable mediums, and loaded into memory 1130 when execution of the computer program instructions is desired. Thus, at least the method steps of FIG. 7 can be defined by the computer program instructions stored in memory 1130 and/or data storage 1120 and controlled by processor 1110 executing the computer program instructions. For example, the computer program instructions can be implemented as computer executable code programmed by one skilled in the art to perform at least the algorithms defined by the method steps of FIG. 7. Computing device 1100 also includes one or more network interfaces for communicating with other devices via a network. Computing device 1100 also includes one or more input/output devices 1150 that enable user interaction with computing device 1100 (e.g., display, keyboard, mouse, speakers, buttons, etc.).

Processor 1110 may include both general and special purpose microprocessors, and may be the sole processor or one of multiple processors of computing device 1100. Processor 1110 may comprise one or more central processing units (CPUs), for example. Processor 1110, data storage device 1120, and/or memory 1130 may include, be supplemented by, or incorporated in, one or more application-specific integrated circuits (ASICs) and/or one or more field programmable gate arrays (FPGAs).

Data storage 1120 and memory 1130 each comprise a tangible non-transitory computer readable storage medium. Data storage 1120, and memory 1130, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1150 may include peripherals, such as a printer, scanner, display screen, etc. For example, input/output devices 1150 may include a display device such as a cathode ray tube (CRT) or liquid crystal display (LCD) monitor for displaying information to the user, a keyboard, and a pointing device such as a mouse or a trackball by which the user can provide input to computing device 1100.

One skilled in the art will readily recognize that any implementation of an actual computer, computer system, or computing device may have other structures and may contain other components, and that computing device 1100 is merely a high level representation of some of the components for illustrative purposes.

All systems and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

All systems and methods described herein may also be implemented using computers operating in a client-server relationship. Typically, in such a system, the client computer is located remotely from the server computer and interaction takes place via a network. The client-server relationship may be defined and controlled by computer programs executing on their respective client and server computers.

All systems and methods described herein may be implemented using a computer program product tangibly embodied in an information carrier, e.g., in a non-transitory machine-readable storage, for execution by a programmable processor; and the method steps described herein may be implemented using one or more computer programs executable by such processor. A computer program may be a set of computer program instructions that can be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

We claim:

1. A non-transitory computer readable medium having executable code stored thereon, that when executed, causes a computing device to perform a method comprising:
displaying media content on a display device;
determining if supplemental content related to the media content is available;
displaying, if it is determined that the supplemental content is available, an indication on the display device to alert a user of the presence of the supplemental content;
receiving user input comprising a selection of the indication;
retrieving the supplemental content from one or more servers in response to the user input; and
displaying the supplemental content on the display device by overlaying the supplemental content on top of the media content.

2. The non-transitory computer readable medium of claim 1, wherein receiving user input comprises receiving one or more of a gesture command, voice command, touch input, and input from a remote control.

3. The non-transitory computer readable medium of claim 1, wherein determining if the supplemental content is available comprises:
sending a request to one or more servers comprising identification information of the media content;
receiving a response from the one or more servers indicating availability of the supplemental content related to the media content.

4. The non-transitory computer readable medium of claim 1, wherein determining if the supplemental content is available comprises:
searching a local storage device for the supplemental content.

5. The non-transitory computer readable medium of claim 1, wherein the supplemental content comprises one or more of audio, video and graphical data.

6. The non-transitory computer readable medium of claim 1, wherein the supplemental content comprises a UI element, the UI element allowing a user to initiate a video chat.

7. The non-transitory computer readable medium of claim 1, wherein the supplemental content includes one or more actionable UI elements.

8. A method for providing supplemental content on a digital device, comprising:
displaying media content on the display device;
determining if supplemental content related to the media content is available;
displaying, if it is determined that the supplemental content is available, an indication on the display device to alert a user of the presence of the supplemental content;
receiving user input comprising a selection of the indication;
retrieving the supplemental content from one or more servers in response to the user input; and
displaying the supplemental content on the display device by overlaying the supplemental content on top of the media content.

9. The method of claim 8, wherein receiving user input comprises receiving one or more of a gesture command, voice command, touch input, and input from a remote control.

10. The method of claim 8, wherein determining if the supplemental content is available comprises:
sending a request to one or more servers comprising identification information of the media content;
receiving a response from the one or more servers indicating availability of the supplemental content related to the media content.

11. The method of claim 8, wherein determining if the supplemental content is available comprises:
searching a local storage device for the supplemental content.

12. The method of claim 8, wherein the supplemental content comprises one or more of audio, video and graphical data.

13. The method of claim 8, wherein the supplemental content comprises a UI element, the UI element allowing a user to initiate a video chat.

14. The method of claim 8, wherein the supplemental content includes one or more actionable UI elements.

15. A system comprising:
an input unit configured for receiving user input;
a display unit;
a storage device; and
a processor configured for:
displaying media content on the display unit;
determining if supplemental content related to the media content is available;
displaying, if it is determined that the supplemental content is available, an indication on the display unit to alert a user of the presence of the supplemental content;
receiving user input comprising a selection of the indication;
retrieving the supplemental content from one or more servers in response to the user input; and
displaying the supplemental content on the display unit by overlaying the supplemental content on top of the media content.

16. The system of claim 15, wherein receiving user input comprises receiving one or more of a gesture command, voice command, touch input, and input from a remote control.

17. The system of claim 15, wherein determining if the supplemental content is available comprises:
sending a request to one or more servers comprising identification information of the media content;
receiving a response from the one or more servers indicating availability of the supplemental content related to the media content.

18. The system of claim 15, wherein determining if the supplemental content is available comprises:
searching a local storage device for the supplemental content.

19. The system of claim 15, wherein the supplemental content comprises one or more of audio, video and graphical data.

20. The system of claim 15, wherein the supplemental content comprises a UI element, the UI element allowing a user to initiate a video chat.
